(19) United States
(12) Patent Application Publication
(10) Pub. No.: US 2025/0175849 A1
(43) Pub. Date: May 29, 2025

(54) METHOD FOR SUPPORTING QOS IN WIRELESS BACKHAUL COMMUNICATION SYSTEMS

(71) Applicant: ELECTRONICS AND TELECOMMUNICATIONS RESEARCH INSTITUTE, Daejeon (KR)

(72) Inventors: Nak Woon SUNG, Daejeon (KR); Hee Sang CHUNG, Daejeon (KR)

(73) Assignee: ELECTRONICS AND TELECOMMUNICATIONS RESEARCH INSTITUTE, Daejeon (KR)

(21) Appl. No.: 18/956,866

(22) Filed: Nov. 22, 2024

(30) Foreign Application Priority Data
Nov. 24, 2023 (KR) 10-2023-0165858

(51) Int. Cl. H04W 28/02; H04W 8/26

(52) U.S. Cl. CPC H04W 28/0268; H04W 8/26

(57) ABSTRACT

Various embodiments of Quality of Service (QoS) support in a wireless backhaul communication system are disclosed. In one embodiment, a method for supporting QoS in a wireless backhaul communication system by a user equipment connected to at least one end user terminal comprises: registering with a mobile communication network; establishing a PDU session with the mobile communication network to support multiple QoS flows; and for each of the at least one end user terminal, selecting one IP address group from among IP address groups corresponding to each of the multiple QoS flows, and allocating an IP address included in the selected IP address group to the corresponding end user terminal.

### CROSS REFERENCE TO RELATED APPLICATION

The present application claims priority to Korean Patent Application No. 10-2023-0165858, filed on Nov. 24, 2023, the entire contents of which are incorporated herein for all purposes by this reference.

### BACKGROUND

### Technical Field

The present disclosure relates to a Quality of Service (QoS) support technology in a wireless backhaul communication system. More particularly,. More specifically, some embodiments relate to a method for supporting QoS when using a 5G mobile communication system and/or an LTE mobile communication system as a wireless backhaul link.

### Description of the Related Art

In LTE mobile communication systems or 5G mobile communication systems, a basic unit of QoS service is an Evolved Packet System (EPS) bearer or a QoS flow.

When such mobile communication systems are used as wireless backhaul links, the number of EPS bearers or QoS flows may increase exponentially in proportion to the number of end users being served. This is because in a wireless backhaul system, a User Equipment (UE) must serve multiple end users with different purposes, and these multiple end users may need to receive service for traffic flows with different characteristics.

The increase in the number of EPS bearers or QoS flows that the wireless backhaul system must support may impose a significant load on the base station. Therefore, when using a mobile communication system as a wireless backhaul link, it may be difficult to provide QoS for each end user or for each traffic flow.

### SUMMARY

Accordingly, when a mobile communication system is used as a wireless backhaul link, a technology that efficiently supports QoS may be required.

One aspect of this disclosure provides a method for supporting Quality of Service (QoS) in a wireless backhaul communication system by a user equipment connected to at least one end user terminal. The method may comprise: registering with a mobile communication network; establishing a Packet Data Unit (PDU) session with the mobile communication network to support multiple QoS flows; and for each of the at least one end user terminal, selecting one IP address group from among IP address groups corresponding to each of the multiple QoS flows, and allocating an IP address included in the selected IP address group to the corresponding end user terminal.

In some embodiments, the selecting step may comprise: receiving a requested QoS from each of the at least one end user terminal; and selecting one from among IP address groups corresponding to each of the multiple QoS flows based on the received requested QoS.

In some embodiments, the method may further comprise: when receiving an uplink packet from any one of the at least one end user terminal, mapping the received uplink packet to a QoS flow corresponding to an IP address group to which an IP address assigned to the end user terminal that transmitted the uplink packet belongs; and transmitting the received uplink packet to the mobile communication network according to the mapped QoS flow.

In some embodiments, the transmitting step may comprise: transmitting the received uplink packet to a base station of the mobile communication network using a Data Radio Bearer (DRB) corresponding to the mapped QoS flow among multiple DRBs that the base station mapped to each QoS flow after the PDU session was established.

In some embodiments, the transmitting step may comprise: performing network address translation processing on the received uplink packet, and transmitting the processed uplink packet to the mobile communication network.

In some embodiments, the transmitting step may comprise: encapsulating the received uplink packet, and transmitting the encapsulated uplink packet to the mobile communication network.

In some embodiments, each of the multiple QoS flows may correspond to each of multiple services classified based on at least one of: guarantee of real-time resource allocation and guarantee of error correction in radio sections.

In some embodiments, the multiple services may include: a first service configured with RLC UM and Non-GBR; a second service configured with RLC AM and Non-GBR; a third service configured with RLC UM and GBR; and a fourth service configured with RLC AM and GBR.

In some embodiments, the user equipment may be connected to the at least one end user terminal via at least one of Wi-Fi and Ethernet.

In some embodiments, the mobile communication network may include a 5G mobile communication network based on 3GPP standards.

Another aspect of this disclosure provides a method for supporting Quality of Service (QoS) in a wireless backhaul communication system by a mobile communication network for at least one end user terminal connected to a user equipment. The method may comprise: performing, by a first network function of the mobile communication network, network registration for the user equipment; establishing, by a second network function of the mobile communication network, a PDU session with the user equipment to support multiple QoS flows, wherein each of the multiple QoS flows corresponds to an IP address group to which an IP address assigned to each of the at least one end user terminal belongs; and transmitting, by the second network function, at least a portion of information about the established PDU session to at least one third network function of the mobile communication network.

In some embodiments, the transmitting step may comprise: transmitting packet detection rules for the established PDU session to a UPF of the mobile communication network.

In some embodiments, the packet detection rules may include QoS parameter information for each of the multiple QoS flows.

In some embodiments, the method may further comprise: mapping, by the UPF, a downlink packet to one of the multiple QoS flows based on the received packet detection rule; and transmitting, by the UPF, the downlink packet to a base station of the mobile communication network according to the mapped QoS flow.

In some embodiments, the transmitting step may comprise: performing network address translation processing on the received downlink packet; and transmitting the processed downlink packet to the base station.

In some embodiments, the transmitting step may comprise: encapsulating the received downlink packet; and transmitting the encapsulated downlink packet to the base station.

In some embodiments, the transmitting step may comprise: transmitting QoS profile information for the established PDU session to a base station of the mobile communication network.

In some embodiments, the method may further comprise: transmitting, by the base station, a downlink packet to the user equipment according to a scheduling policy based on the QoS profile information.

In some embodiments, the transmitting to the user equipment may comprise: transmitting the received downlink packet to the user equipment using a DRB corresponding to the QoS flow mapped to the received downlink packet among multiple DRBs that the base station mapped to each of the multiple QoS flows after the PDU session was established.

In some embodiments, the first network function may include an Access and Mobility Function (AMF), and the second network function may include a Session Management Function (SMF).

Yet another aspect of this disclosure provides an electronic device comprising: a processor; one or more hardware-based transceivers; and a computer-readable storage medium containing instructions, which, when executed by the processor, cause the electronic device to perform at least one embodiment of the method of this disclosure.

Yet another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, QoS can be efficiently supported when using a mobile communication system as a wireless backhaul link.

According to some embodiments, when using a mobile communication system as a wireless backhaul link, QoS requirements of multiple end user terminals for the wireless backhaul link can be guaranteed.

### BRIEF DESCRIPTION OF THE DRAWINGS

FIG. 1 is a diagram illustrating an LTE mobile communication system.

FIG. 2 is a diagram illustrating QoS control through EPS bearer(s) in an LTE network.

FIG. 3 is a diagram illustrating an architecture reference model in a 5G network.

FIG. 4 is a flowchart illustrating several embodiments of QoS support in a wireless backhaul communication system.

FIG. 5 is a diagram illustrating the mapping between DRBs and QoS flows during downlink traffic transmission.

FIG. 6 is a diagram illustrating the user plane protocol structure of a 5G network.

FIG. 7 is a diagram illustrating some embodiments of QoS support in a wireless backhaul communication system.

FIG. 8 is a diagram illustrating some embodiments of QoS support in a wireless backhaul communication system.

FIG. 9 is a diagram illustrating some embodiments of QoS support in a wireless backhaul communication system.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

An ITE mobile communication system may comprise UE(s), base station(s), and a core network.

When initially accessing the LTE network, the UE requests a connection with a Packet Data Network (PDN).

In response, the PDN Gateway (P-GW) of the core network assigns an IP address to the UE for data transmission and establishes a default EPS bearer between the UE and the P-GW.

The established default EPS bearer is maintained until the UE is detached from the LTE network.

Therefore, for each PDN, the default EPS bearer and the PDN address (i.e., IP address) assigned to the UE are unique within one PDN.

Meanwhile, to support new QoS, the terminal and P-GW can establish additional dedicated bearers.

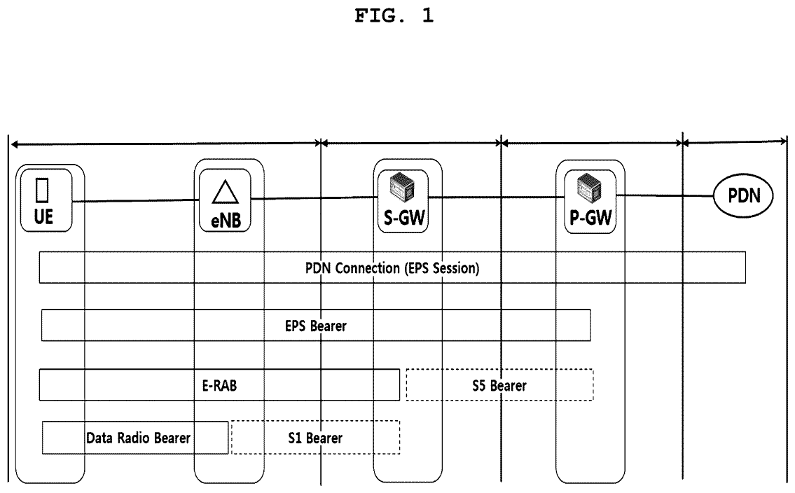

FIG. 1 is a diagram illustrating an LTE mobile communication system.

As illustrated in FIG. 1, the EPS bearer is a traffic path section from the UE to the P-GW during an EPS session.

The EPS bearer consists of three sections: DRB, S1 bearer, and S5 bearer. User traffic is delivered through the corresponding bearer for each section. For example, the DRB is the Uu interface section between the terminal and the LTE base station, where user traffic is transmitted wirelessly through the DRB. As another example, the S1 bearer is the S1-U interface section between the LTE base station and the Serving Gateway (S-GW), where user traffic is transmitted via a GTP tunnel over wire. As yet another example, the S5 bearer is the S5 interface section between the S-GW and P-GW, where user traffic is transmitted via a GTP tunnel over wire.

Thus, the EPS bearer is structured with <DRB-S1 bearer-S5 bearer> using the UE and the P-GW as endpoints, while the E-RAB (E-UTRAN Radio Access Bearer) is structured with <DRB-S1 bearer> using the UE and the S-GW as endpoints.

Meanwhile, the P-GW defines packet filtering rules for IP packet classification for both downlink and uplink.

The LTE network provides EPS bearers, which are user traffic transmission paths that support various QoS according to the UE's application services, and assigns an EPS bearer ID to each of the provided EPS bearer.

The EPS bearer provides the same QoS, such as the same Maximum Bit Rate (MBR) or the same Guaranteed Bit Rate (GBR), for services of the same class between the UE and P-GW.

Therefore, IP flows generated from each application service must be classified according to each QoS class.

For this purpose, the P-GW uses a Service Data Flow (SDF) template to classify incoming IP flows into SDFs for each class and provides corresponding QoS. The P-GW also provides mapping functionality between IP flows classified according to the SDF template and EPS bearers.

The SDF template consists of IP packet filters. Each IP packet filter consists of 5-tuple based filter rules (Source IP, Destination IP, Source Port Number, Destination Port Number, Protocol ID). According to these filter rules, an IP flow entering the P-GW are classified into one SDF. Subsequently, the P-GW maps to an EPS bearer that can support the QoS of the SDF using a TFT (Traffic Flow Template) filter.

For this mapping, the LTE mobile communication system defines QoS parameters per SDF (e.g., QCI, ARP, MBR, GBR) and QoS parameters per EPS bearer (e.g., QCI, ARP, MBR, GBR, UE-AMBR, APN-AMBR).

The QoS parameters per EPS bearer consist of the same content as the QoS parameters per SDF, and parameters for the access system may be added. Therefore, SDFs with the same SDF QoS parameters can be mapped to one EPS bearer for delivery. If a certain SDF cannot be serviced by the current EPS bearer, it may be delivered by creating a new EPS bearer.

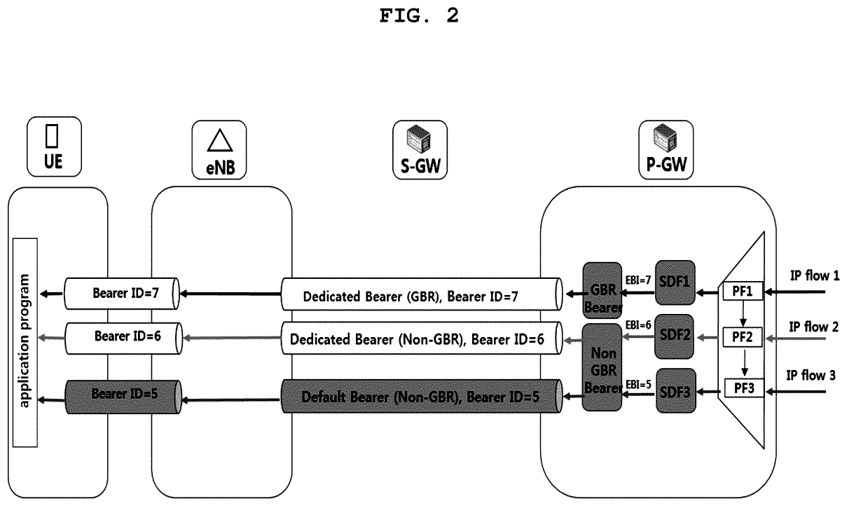

FIG. 2 is a diagram illustrating QoS control through EPS bearer(s) in an LTE network.

As illustrated in FIG. 2, the P-GW may receive IP flow packets from the PDN. For example, in FIG. 2, IP flow 1, IP flow 2, and IP flow 3 may be gaming data, video streaming data, and best effort data, respectively.

Next, the P-GW may classify the received IP flows into specific SDFs through IP packet filters. For example, according to the 5-tuple TFT rules, IP flow 1, IP flow 2, and IP flow 3 may be classified as GBR-type SDF 1, non-GBR-type SDF 2, and non-GBR-type SDF 3, respectively.

Next, the P-GW may map each of the SDFs, into which IP packets have been classified as described above, to specific EPS bearers according to Forward Link TFT rules. For example, as illustrated in FIG. 2, SDF 1, SDF 2, and SDF 3 may be mapped to a GBR-type dedicated bearer (bearer ID=7), a non-GBR-type dedicated bearer (bearer ID=6), and a non-GBR-type default bearer (bearer ID=5), respectively, and transmitted to the base station (e.g., eNB in FIG. 2).

Next, the base station may schedule the GBR-type dedicated bearer (bearer ID=7) to satisfy the corresponding GBR-type QoS, and map it to a GBR-type radio bearer for transmission to the UE (e.g., UE in FIG. 2). Similarly, the base station may schedule the non-GBR-type dedicated bearer (bearer ID=6) and the non-GBR-type default bearer (bearer ID=5) to meet their respective QoS requirements, mapping them to non-GBR-type radio bearers for transmission to the UE.

Therefore, in the LTE network, the same QoS may be provided for services of the same class between the UE and P-GW through the EPS bearer configured as <DRB-S1 bearer-S5 bearer>.

Meanwhile, in 5G mobile communication standards, eMBB (enhanced Mobile Broadband), URLLC (Ultra Reliable Low Latency Communication), and MTC (Machine Type Communication) are defined as representative services, and new RAT (Radio Access Technology) and core network architectures have been proposed.

While the LTE core network, EPC (Evolved Packet Core), defines functions, connection points, and protocols for each entity such as MME (Mobility Management Entity), S-GW, and P-GW, the 5G core network defines functions, connection points, and protocols by Network Function (NF) rather than by entity.

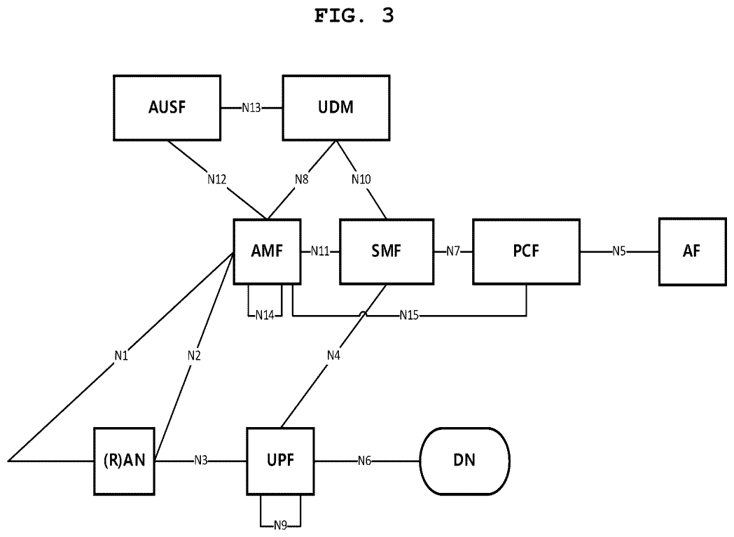

FIG. 3 is a diagram illustrating an architecture reference model in a 5G network.

In FIG. 3, RAN represents a base station using new RAT, and (R) AN represents a general base station including non-3GPP access technologies such as Wi-Fi.

As illustrated in FIG. 3, RAN and AMF (Access and Mobility Function) are connected via reference point N2.

RAN and User Plane Function (UPF) are connected via reference point N3, as illustrated in FIG. 3.

Meanwhile, the core network consists of various Control Plane Functions (CPF) for controlling the network and UEs, and UPF for processing user traffic.

The CPF comprises multiple independent functions.

AMF provides network registration and mobility management functions, while SMF (Session Management Function) provides session management functions. While each UE is basically connected to one AMF for network registration, in case multiple sessions are established, each session may be assigned to different SMFs and managed separately.

PCF (Policy Control Function) provides policy control functions.

AF (Application Function) provides packet flow information to PCF to ensure QoS.

The AMF and SMF perform their respective functions based on policies (e.g., for mobility management, session management, and QoS management) provided by the PCF.

DN (Data Network) transmits and receives downlink and uplink traffic to/from the UE via the UPF, with the reference point between the DN and UPF defined as N6.

Meanwhile, during session establishment, configures the UPF by passing control signal information, and the UPF reports its status back to the SMF. The reference point between these two functions is defined as N4.

The UE may perform network registration procedures with the AMF using the Uu reference point. During such network registration procedures, the AMF stores authentication data, communicates with AUSF (Authentication Server Function) via reference point N12, and communicates with UDM (User Data Management), which stores user subscription data, policy data, etc., via reference point N8.

Meanwhile, the 5G network QoS framework may have differences from the aforementioned LTE network QoS framework. For example, in 5G networks, the QoS flow concept replaces the bearer concept.

A QoS flow represents user traffic flows that guarantee the same QoS within a PDU session, and this QoS flow has several differences from LTE's EPS bearer:

First, while the LTE mobile communication system requires explicit ESM (EPS Session Management) signaling procedures for creating each EPS bearer, 5G has no procedure for creating each QoS flow. For example, during PDU session establishment, QoS flows may be created simultaneously for each QoS service to be supported within the PDU session. A QoS Flow Identifier (QFI) may be assigned to each created QoS flow.

Second, in LTE mobile communication systems, packet flows are mapped to specific EPS bearers according to TFT rules (packet filters). If an LTE mobile communication system wants to move a packet flow to another EPS bearer, it must perform a signaling procedure to modify the TFT rules. In contrast, 5G mobile communication systems may adjust to different QoS by simply changing QFI values in real-time without explicit signaling procedures.

Third, in LTE mobile communication systems, each EPS bearer corresponds to a UE-specific <S1U GTP tunnel-S5 GTP tunnel>. Therefore, each user traffic is delivered only through the established EPS bearer. In contrast, in 5G mobile communication systems, there exists one GTP tunnel between RAN and UPF, and each QoS flow shares this GTP tunnel for packet transmission.

Fourth, in LTE mobile communication systems, the EPS bearer section between UE and RAN is a DRB section consisting of PDCP (Packet Data Convergence Protocol), RLC (Radio Link Control), and MAC (Medium Access Control) entities, and is mapped 1:1 UE-specifically with the S1U GTP tunnel constituting the EPS bearer. In contrast, in 5G networks, there is no strictly defined 1:1 mapping relationship between QoS flows and DRBs, and each QoS flow may be mapped to any DRB according to scheduling policy to guarantee QoS.

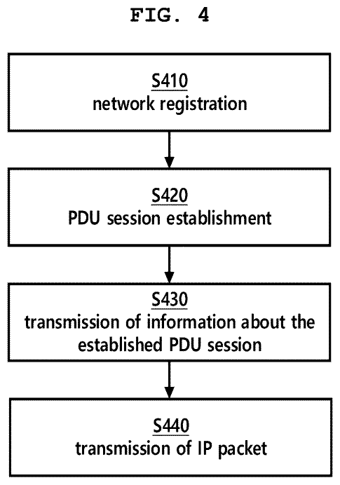

FIG. 4 is a flowchart illustrating several embodiments of QoS support in a wireless backhaul communication system.

In some embodiments, as illustrated in FIG. 4, network registration of a UE to a mobile communication network may be performed (S410). For example, the UE may perform a network registration procedure when powered on.

In some embodiments, the mobile communication network may be a 3GPP 5G mobile communication network. In other embodiments, the mobile communication network may be a 3GPP LTE mobile communication network. In yet other embodiments, the mobile communication network may be a next-generation (e.g., 6G) mobile communication network for 3GPP 5G mobile communication network.

In some embodiments, a first network function of the mobile communication network may perform network registration for the UE. In some embodiments, the first network function may include AMF.

In some embodiments, as illustrated in FIG. 4, a PDU session may be established (S420). In some embodiments, the UE may establish a PDU (Packet Data Unit) session with the mobile communication network to support multiple QoS flows. In some embodiments, a second network function of the mobile communication network may establish the PDU session with the UE. In some embodiments, the second network function may include SMF.

In some embodiments, as illustrated in FIG. 4, at least a portion of information regarding the established PDU session may be delivered to at least one network function to perform preparation for a wireless backhaul communication system (S430). In some embodiments, the SMF of the mobile communication network may deliver at least a portion of information regarding the established PDU session to at least one third network function of the mobile communication network. For example, the SMF may deliver packet detection rules for the established PDU session to the UPF of the mobile communication network. In some embodiments, the packet detection rules may include QoS parameter information for each of the multiple QoS flows. As another example, the SMF may deliver QoS profile information for the established PDU session to the base station of the mobile communication network.

In some embodiments, the UE may be connected to at least one end user terminal via wired or wireless connection. For example, the UE may be connected to the at least one end user terminal via Wi-Fi. As another example, the user equipment may be connected to the at least one end user terminal via Ethernet.

In some embodiments, for each of the at least one end user terminal connected via wired or wireless connection, the UE may select one from IP address groups corresponding to each of the multiple QoS flows, and assign an IP address included in the selected IP address group to the corresponding end user terminal. For example, the UE may receive requested QoS from each of the at least one end user terminal and select one from IP address groups corresponding to each of the multiple QoS flows based on the received requested QoS.

In some embodiments, each of the multiple QoS flows may correspond to each of multiple services classified based on at least one of guarantee of real-time resource allocation and guarantee of error correction in radio sections. For example, the multiple services may include a first service configured with RLC UM and Non-GBR, a second service configured with RLC AM and Non-GBR, a third service configured with RLC UM and GBR, and a fourth service configured with RLC AM and GBR.

In some embodiments, as illustrated in FIG. 4, IP packets may be transmitted through a wireless backhaul communication system (S440). In some embodiments, when the UE receives an uplink packet from any one of the at least one end user terminal, the UE may map the received uplink packet to a QoS flow corresponding to an IP address group to which the IP address assigned to the end user terminal that transmitted the uplink packet belongs, and transmit the received uplink packet to the mobile communication network according to the mapped QoS flow.

In some embodiments, the UE may transmit the received uplink packet to a base station using a DRB corresponding to the mapped QoS flow among a plurality of DRBs (Data Radio Bearers) that the base station of the mobile communication network mapped to each of the plurality of QoS flows after the PDU session was established.

In some embodiments, the UE may perform network address translation processing on the received uplink packet and transmit the processed uplink packet to the mobile communication network. In some other embodiments, the UE may encapsulate the received uplink packet and transmit the encapsulated uplink packet to the mobile communication network.

In some embodiments, the UPF may map a downlink packet to one of the plurality of QoS flows based on the received packet detection rules, and transmit the downlink packet to the base station of the mobile communication network according to the mapped QoS flow. In some embodiments, the UPF may perform network address translation processing on the received downlink packet and transmit the processed downlink packet to the base station. In some other embodiments, the UPF may encapsulate the received downlink packet and transmit the encapsulated downlink packet to the base station.

In some embodiments, the base station may transmit downlink packets to the UE according to a scheduling policy based on the QoS profile information. For example, the base station may transmit the received downlink packet to the UE using a DRB corresponding to the QoS flow mapped to the received downlink packet among a plurality of DRBs that the base station mapped to each of the plurality of QoS flows after the PDU session was established.

Some embodiments of PDU session establishment and wireless backhaul service preparation operations in a 5G network are as follows.

When powered on, the UE may perform a network registration procedure with the AMF. The UE may generate and transmit a PDU Session Establishment Request message to the AMF.

The AMF may select an SMF and forward the received PDU session establishment request message to the selected SMF.

The SMF may select a UPF and transmit information about the PDU session to be created to the selected UPF. The SMF may transmit information about the PDU session to be created (PDU session ID, QoS profile information, CN tunnel information) and a PDU Session Establishment Accept message to the AMF.

Here, the CN (Core Network) tunnel information may consist of the UPF-side IP address and TEID (Tunnel Id) of the N3 tunnel for uplink traffic transmission between the UPF and RAN.

The QoS profile information may consist of QoS rule information generated within the PDU session. Each QoS rule is defined on a QoS flow basis to be supported and may consist of a tuple of <QFI, multiple Packet Filters>.

Based on the PDU session-related information, the RAN may perform a DRB setup process with the UE and transmit a PDU Session Establishment Accept message to the UE during this process. Meanwhile, the RAN may simultaneously deliver RAN tunnel information, including the RAN-side IP address and TEID information of the N3 tunnel for downlink traffic transmission, to the AMF. Such RAN tunnel information may be delivered back through the SMF to the UPF to complete preparation for downlink traffic transmission.

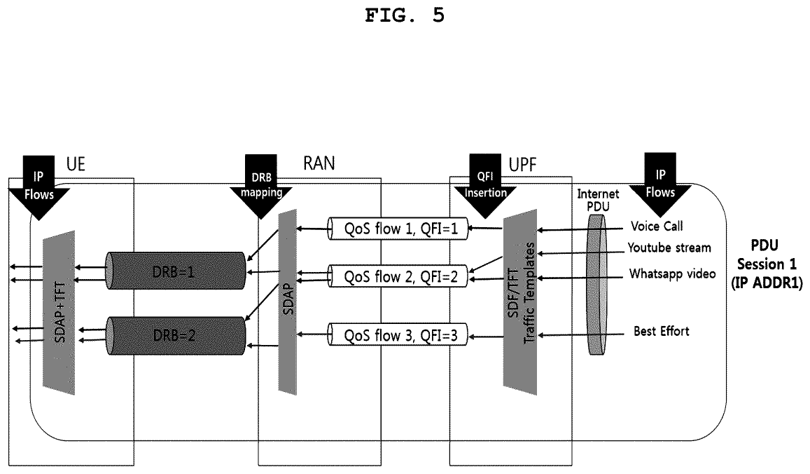

FIG. 5 is a diagram illustrating the mapping between DRBs and QoS flows during downlink traffic transmission.

Through the aforementioned PDU session establishment process, as illustrated in FIG. 5, a PDU session identified as PDU Session 1 is created, and the UE is assigned an IP address of IP ADDR1. The SMF creates three QoS flows for PDU Session 1, transmits QoS rule information corresponding to the three created QoS flows to the UE using the PDU Session Establishment Accept message, and generates QoS profile information which is transmitted to the RAN through the AMF. The SMF then delivers this PDU session configuration information to the UPF.

Referring to FIG. 5, the UPF, through packet filtering, assigns QFI=1 to voice call traffic and transmits it to the RAN, assigns QFI=2 to YouTube stream and WhatsApp video stream packets and transmits them to the RAN. And for Best effort internet traffic, it assigns QFI=3 and transmits it to the RAN.

The RAN verifies the QFI for the received traffic and transmits the received traffic to the UE using DRB(s) according to a scheduling policy based on the QoS profile information. In this case, which DRB is used to transmit each QoS flow may vary depending on implementation. For example, the QFI=1 flow may be mapped to and transmitted through DRB=1, the QFI=2 flow may be mapped to and transmitted through either DRB=1 or DRB=2, and the QFI=3 flow may be mapped to and transmitted through DRB=2.

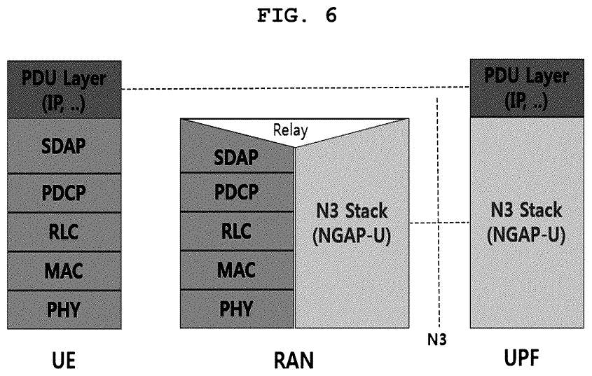

FIG. 6 is a diagram illustrating the user plane protocol structure of a 5G network.

The user plane is a protocol stack for user data transmission where the physical layer transmits data to upper layers using physical channels. The physical channel uses OFDM as a modulation method, utilizes time and frequency as radio resources, and is connected to the MAC layer, which is an upper layer, through a transport channel.

The MAC layer performs mapping functions between logical channels and physical channels, performs multiplexing functions of MAC SDU (service data unit) into transport blocks on the physical channel and demultiplexing functions, and performs error correction functions using HARQ (Hybrid automatic repeat request) functionality.

The RLC (Radio Link Control) layer performs segmentation and reassembly functions, operates in one of TM (Transparent Mode), UM (Unacknowledged Mode), and AM (Acknowledged Mode) to guarantee various QoS requirements of the Radio Bearer (RB), and provides error correction functionality through ARQ.

The PDCP (Packet Data Convergence Protocol) layer performs sequential delivery of user data, header compression, and ciphering functions.

The SDAP (Service Data Adaptation Protocol) layer performs QoS flow mapping functions.

The 5G network protocol stack can be divided into AS (Access Stratum) protocol functions for control signal transmission between the UE and base station, and NAS (Non Access Stratum) protocol layer for control signal transmission between the UE and core network.

The AS protocol layer includes SDAP, PDCP, RRC, RLC, MAC, and PHY protocols and terminates at the base station, i.e., RAN.

Radio bearers may be established by the RRC protocol layer in the control plane. The RRC protocol layer performs control functions for logical channels, transport channels, and physical channels by performing configuration, re-configuration, and release functions of radio bearers.

Meanwhile, radio bearers may be classified into SRB (Signaling RB) that transmits RRC messages in the control plane and DRB that transmits user traffic in the user plane. These SRB and DRB are configured with the aforementioned 5G AS protocol layer functions.

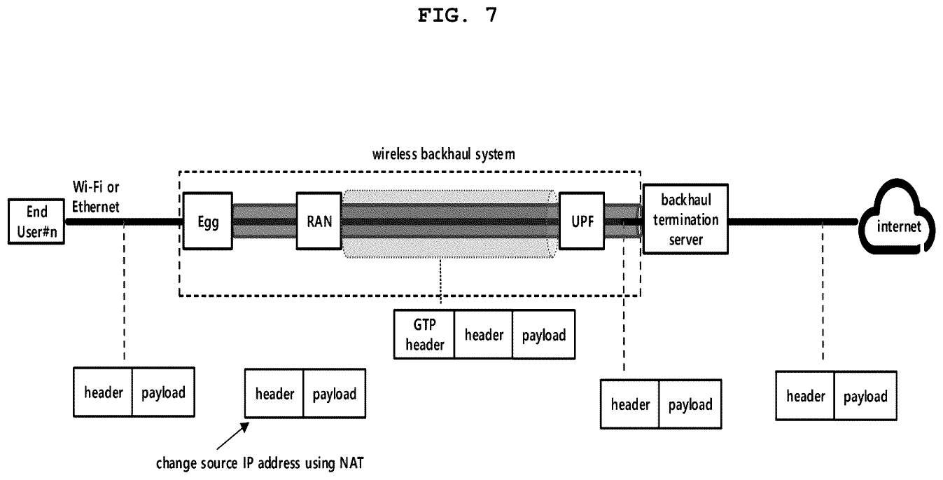

FIG. 7 is a diagram illustrating some embodiments of QoS support in a wireless backhaul communication system.

In some embodiments, the mobile communication system may be a 5G mobile communication system. In some other embodiments, the mobile communication system may be an LTE mobile communication system.

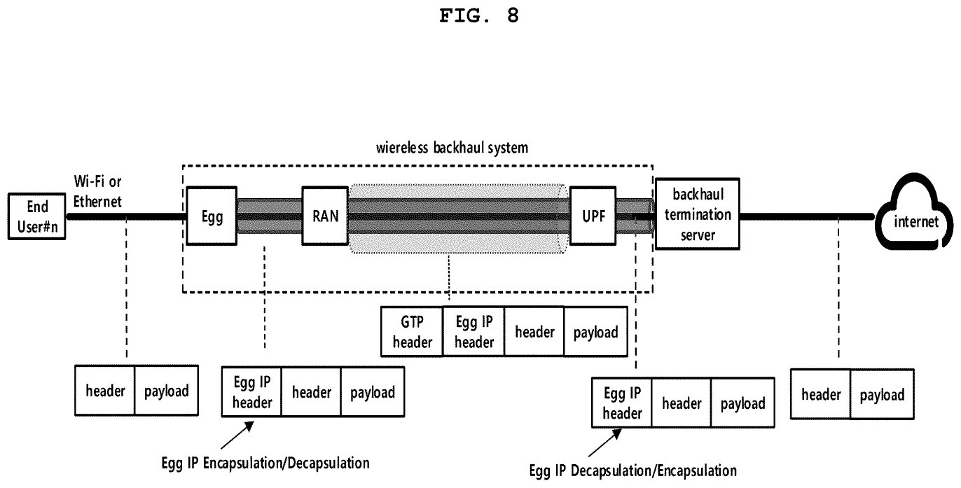

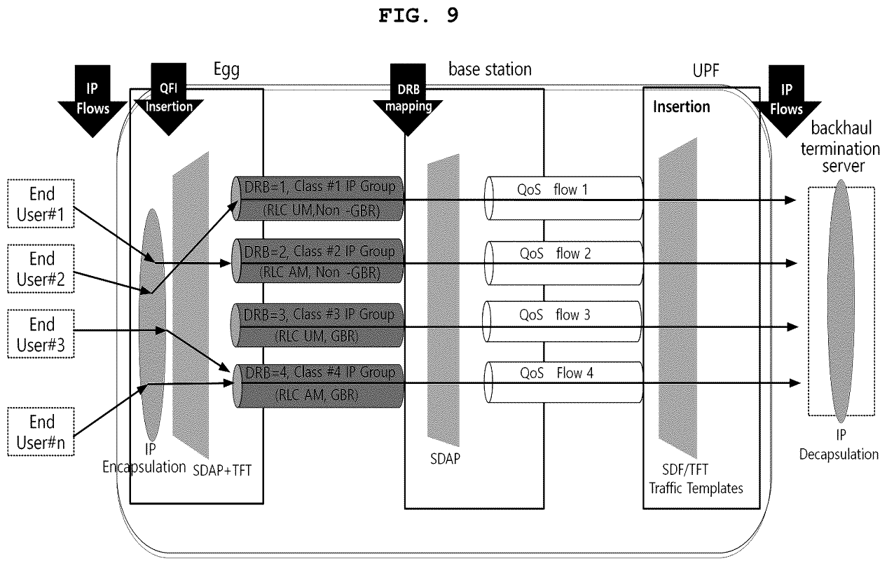

In some embodiments, the UE, base station, and network functions of the mobile communication network in the wireless backhaul system of FIG. 7 may perform the same or similar operations as the UE, base station, and network functions of the mobile communication network in some embodiments of FIG. 8 or 9 to provide wireless backhaul services between an end user terminal and a backhaul termination server.

In some embodiments, as illustrated in FIG. 7, the wireless backhaul system may comprise a UE (Egg), RAN, and UPF belonging to the mobile communication system.

In some embodiments, the RAN may include a base station.

In some embodiments, the UE may be connected to at least one end-user terminal via wired or wireless connection. For example, the UE may be an Egg device. An example of wired connection may include Ethernet, but is not necessarily limited thereto. An example of wireless connection may include Wi-Fi, but is not necessarily limited thereto.

In some embodiments, as illustrated in FIG. 7, the wireless backhaul system may provide wireless backhaul service between an end-user terminal (End user #n) and a backhaul termination server.

In some embodiments, the UE may provide wireless backhaul service to multiple end-user terminals. For example, packets generated from multiple end-user terminals may be backhauled to the backhaul termination server.

In some embodiments, when the UE is powered on, the UE may perform a network registration process. In some embodiments, a PDU session establishment process may be performed to provide traffic service. In some embodiments, during the PDU session establishment process, the UE may receive an IP address allocation from the SMF and receive QoS rule information for QoS flows and uplink traffic to be configured.

In some embodiments, the SMF may deliver packet detection rules (PDR) for the established PDU session to the UPF. In some embodiments, the packet detection rules may include QoS flow and QoS parameter information.

In some embodiments, the UPF may classify downlink packets and map them to appropriate QoS flows based on the received PDR.

In some embodiments, the SMF may provide QoS profile information for the established PDU session to the base station to enable mapping between QoS flows and DRBS.

In some embodiments, the UE may assign IP addresses to end-user terminals. For example, the UE may operate as a DHCP (Dynamic Host Configuration Protocol) server, and end-user terminals may dynamically receive IP address assignments from the UE.

In some embodiments, when an end-user terminal wants to transmit an uplink packet to the backhaul termination server, the UE may perform Network Address Translation (NAT) on the uplink packet received from the end-user terminal. For example, the source IP address of the IP packet generated at the end-user terminal may be replaced with the UE's IP address.

In some embodiments, the uplink packet with NAT applied (for example, the IP packet including the replaced IP address) may be mapped to a QoS flow according to the UE's QoS rules for transmission. For example, at the UE's SDAP layer, the uplink packet may be transmitted to the base station through a DRB corresponding to the mapped QoS flow.

In some embodiments, the uplink packet transmitted to the base station may be transmitted to the UPF through a GTP tunnel between the base station and the UPF. In some embodiments, the UPF may remove the GTP tunnel header from the received IP packet and forward the IP packet to the backhaul termination server.

FIG. 8 is a diagram illustrating some embodiments of QoS support in a wireless backhaul communication system.

In some embodiments, the UE (Egg), base station, and mobile communication network functions of the wireless backhaul system in FIG. 8 may perform identical or similar operations to those of the UE, base station, and network functions of the mobile communication network in some embodiments of FIG. 7 or FIG. 9 to provide wireless backhaul service between an end-user terminal and a backhaul termination server.

In some embodiments, when the UE is powered on, it may perform network registration and PDU session establishment procedures, and receive IP address allocation and QoS rule information for uplink traffic.

In some embodiments, the SMF may provide PDR information for the established PDU session to the UPF, and provide QoS profile information for the established PDU session to the RAN.

In some embodiments, the UE may operate as a DHCP server for end-user terminals to dynamically assign IP addresses.

In some embodiments, instead of NAT functionality, the UE and UPF may perform encapsulation and decapsulation functions using the UE's IP address for the end-user terminal's IP packets. For example, for uplink packets, the UE may perform encapsulation and the UPF may perform decapsulation. For another example, for downlink packets, the UE may perform decapsulation and the UPF may perform encapsulation.

In some embodiments, the UE may provide QoS service for the traffic according to general 5G QoS mechanisms. For example, when there are not many end-user terminals, the UE may create new QoS flows according to the traffic characteristics of each end-user terminal to provide QoS service for the corresponding traffic.

In some other embodiments, in providing 5G wireless backhaul service, the UE may group end-user terminals and create different QoS flows for each group to provide QoS service for the corresponding traffic. For example, end-users using the wireless backhaul link may be defined into different QoS groups according to requested QoS, and different IP address groups may be assigned to each defined QoS group to guarantee QoS for each IP address group.

According to these embodiments, the problem of increasing number of traffic flows requiring QoS service support as the number of end-user terminals increases may be solved. For example, these embodiments may provide more efficient QoS mechanisms in special purpose cases such as military applications. For example, in military applications, the required degree of QoS may differ according to the rank of users corresponding to end-user terminals. For another example, end-user terminals used for delivering CCTV footage for coastal guard post surveillance can continuously guarantee specific QoS.

In some embodiments, the UE may classify each end-user terminal into one of multiple QoS groups. In some embodiments, the multiple QoS groups may have different IP address groups, and each IP address group may include at least one IP address.

In some embodiments, the multiple QoS groups may be configured according to whether real-time resource allocation is guaranteed and whether error correction is guaranteed in the wireless section.

In some embodiments, regarding real-time resource allocation guarantee, multiple QoS groups may be configured based on whether the service is GBR or Non-GBR service. GBR service guarantees fixed resource allocation for the corresponding traffic, and non-GBR service allocates maximum available resources in a Best-Effort manner for the corresponding traffic. Therefore, in some embodiments, the wireless backhaul system may provide QoS by distinguishing between real-time and non-real-time services.

In some embodiments, regarding error correction guarantee in the wireless section, multiple QoS groups may be configured according to whether RLC UM or RLC AM is used. This is related to error correction and is a parameter that significantly affects traffic latency. In wireless backhaul service, DRB error correction methods are primarily categorized into HARQ error correction provided by the MAC layer and ARQ error correction provided by the RLC layer. The HARQ error correction method is mostly provided by default and has low latency, while the ARQ method has high latency and may be selectively chosen according to the service.

Table 1 is a table for explaining some embodiments of mapping between QoS groups and IP address groups.

TABLE 1

| | Non-GBR Service | GBR Service | |
|---|---|---|---|
| RLC UM | Class #1 IP address group | Class | #3 IP address group |
| RLC AM | Class #2 IP address group | Class | #4 IP address group |

In some embodiments, separate from 5G QI (QoS Identifier) used in 5G systems and QCI (QoS Class Index) used in LTE, QoS Classes may be defined as shown in Table 1.

In some embodiments, as shown in Table 1, end-user terminals may be classified into four QoS groups.

In some embodiments, as shown in Table 1, the user equipment may set up four IP address groups and select one of the four IP address groups based on the end-user terminal's QoS requirements, and assign an IP address from the selected IP address group to the end-user terminal.

In some embodiments, the user equipment may assign four different IP address groups for each of the defined four QoS groups.

In some embodiments, when dynamically assigning DHCP IP addresses to end-user terminals, the user equipment may select one of the four IP address groups based on the end-user terminal's service request, and assign an IP address included in the selected IP address group to the corresponding end-user terminal.

In some embodiments, each end-user terminal may select a QoS group according to its QoS characteristics and request IP address allocation corresponding to the selected group from the user equipment. In this case, the user equipment may select and assign an IP address from the IP address group requested by the end-user terminal to the end-user terminal.

FIG. 9 is a diagram illustrating some embodiments of QoS support in a wireless backhaul communication system.

In some embodiments, the UE (Egg), base station, and network functions of the mobile communication network in the wireless backhaul system of FIG. 9 may perform identical or similar operations to those of the UE, base station, and network functions of the mobile communication network in some embodiments of FIG. 7 or FIG. 8 to provide wireless backhaul service between an end-user terminal and a backhaul termination server.

In some embodiments, the user equipment may perform network registration procedure and PDU session establishment procedure.

In some embodiments, to provide the four types of QoS classifications illustrated in Table 1, the user equipment may request the SMF to create four QoS flows during PDU session establishment.

In some embodiments, the SMF may define QoS parameter information so that the configured four QoS flows can support each service group exemplified in Table 1, and provide the corresponding parameters to the user equipment and UPF.

In some embodiments, the SMF may also provide QoS profile information for the configured four QoS flows to the base station.

In some embodiments, the base station may create four DRBs to support the four QoS flows defined in the established PDU session in a 1:1 mapping.

When the PDU session establishment process is successfully performed, as illustrated in FIG. 9, DRB1 services the Class #1 IP address group and is mapped 1:1 with QoS flow 1. Traffic mapped to DRB1 may be serviced in a best-effort manner without error correction functionality of the RLC layer.

Similarly, as illustrated in FIG. 9, DRB2 services the Class #2 IP address group and is mapped 1:1 with QoS flow 2. Traffic mapped to DRB2 may receive error correction functionality support from the RLC layer and be serviced in a best-effort manner.

Similarly, as illustrated in FIG. 9, DRB3 services the Class #3 IP address group and is mapped 1:1 with QoS flow 3. Traffic mapped to DRB3 may be serviced in real-time manner without error correction functionality of the RLC layer. Similarly, as illustrated in FIG. 9, DRB4 services the Class #4 IP address group and is mapped 1:1 with QoS flow 4. Traffic mapped to DRB4 may receive error correction functionality support from the RLC layer and be serviced in real-time manner.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of a processor digital computer. Generally, will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer and may include both computer storage media and transmission media.

The present specification includes details of a number of specific implements, but it should be understood that the details limit any invention or what is claimable in the do not specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for supporting Quality of Service (QoS) in a wireless backhaul communication system by a user equipment connected to at least one end user terminal, the method comprising:
registering with a mobile communication network;
establishing a Packet Data Unit (PDU) session with the mobile communication network to support multiple QoS flows; and
for each of the at least one end user terminal, selecting one IP address group from among IP address groups corresponding to each of the multiple QoS flows, and allocating an IP address included in the selected IP address group to the corresponding end user terminal.

2. The method of claim 1, wherein the selecting step comprises:
receiving a requested QoS from each of the at least one end user terminal; and
selecting one from among IP address groups corresponding to each of the multiple QoS flows based on the received requested QoS.

3. The method of claim 1, further comprising:
when receiving an uplink packet from any one of the at least one end user terminal, mapping the received uplink packet to a QoS flow corresponding to an IP address group to which an IP address assigned to the end user terminal that transmitted the uplink packet belongs; and
transmitting the received uplink packet to the mobile communication network according to the mapped QoS flow.

4. The method of claim 3, wherein the transmitting step comprises:
transmitting the received uplink packet to a base station of the mobile communication network using a Data Radio Bearer (DRB) corresponding to the mapped QoS flow among multiple DRBs that the base station mapped to each QoS flow after the PDU session was established.

5. The method of claim 3, wherein the transmitting step comprises:
performing network address translation processing on the received uplink packet, and transmitting the processed uplink packet to the mobile communication network.

6. The method of claim 3, wherein the transmitting step comprises:
encapsulating the received uplink packet, and transmitting the encapsulated uplink packet to the mobile communication network.

7. The method of claim 1, wherein each of the multiple QoS flows corresponds to each of multiple services classified based on at least one of: guarantee of real-time resource allocation and guarantee of error correction in radio sections.

8. The method of claim 7, wherein the multiple services include:
a first service configured with RLC UM and Non-GBR;
a second service configured with RLC AM and Non-GBR;
a third service configured with RLC UM and GBR; and
a fourth service configured with RLC AM and GBR.

9. The method of claim 1, wherein the user equipment is connected to the at least one end user terminal via at least one of Wi-Fi and Ethernet.

10. The method of claim 1, wherein the mobile communication network includes a 5G mobile communication network based on 3GPP standards.

11. A method for supporting QoS in a wireless backhaul communication system by a mobile communication network for at least one end user terminal connected to a user equipment, the method comprising:
performing, by a first network function of the mobile communication network, network registration for the user equipment;
establishing, by a second network function of the mobile communication network, a Packet Data Unit (PDU) session with the user equipment to support multiple QoS flows, wherein each of the multiple QoS flows corresponds to an IP address group to which an IP address assigned to each of the at least one end user terminal belongs; and
transmitting, by the second network function, at least a portion of information about the established PDU session to at least one third network function of the mobile communication network.

12. The method of claim 11, wherein the transmitting step comprises:
transmitting packet detection rules for the established PDU session to a User Plane Function (UPF) of the mobile communication network.

13. The method of claim 12, wherein the packet detection rules include QoS parameter information for each of the multiple QoS flows.

14. The method of claim 12, further comprising:
mapping, by the UPF, a received downlink packet to one of the multiple QoS flows based on the received packet detection rules; and
transmitting, by the UPF, the downlink packet to a base station of the mobile communication network according to the mapped QoS flow.

15. The method of claim 14, wherein the transmitting step comprises:
performing network address translation processing on the received downlink packet; and transmitting the processed downlink packet to the base station.

16. The method of claim 14, wherein the transmitting step comprises:
encapsulating the received downlink packet; and
transmitting the encapsulated downlink packet to the base station.

17. The method of claim 11, wherein the transmitting step comprises:
transmitting QoS profile information for the established PDU session to a base station of the mobile communication network.

18. The method of claim 17, further comprising:
transmitting, by the base station, a received downlink packet to the user equipment according to a scheduling policy based on the QoS profile information.

19. The method of claim 18, wherein the transmitting to the user equipment comprises:
transmitting the received downlink packet to the user equipment using a Data Radio Bearer (DRB) corresponding to the QoS flow mapped to the received downlink packet among multiple DRBs that the base station mapped to each of the multiple QoS flows after the PDU session was established.

20. The method of claim 11, wherein the first network function includes an Access and Mobility Function (AMF), and the second network function includes a Session Management Function (SMF).
